(19) United States
(12) Patent Application Publication
(10) Pub. No.: US 2026/0238235 A1
(43) Pub. Date: Aug. 13, 2026

(54) MULTIBAND RADIO SYSTEMS AND METHODS WITH QUADPLEXER AND SINGLE FRONT-TO-BACK END COAXIAL CONNECTOR CABLE

(71) Applicant: GM GLOBAL TECHNOLOGY OPERATIONS LLC, Detroit, MI (US)

(72) Inventors: Uriel Z. Odes, Givaat Shmuel (IL); Yossi Diller, Petah Tikva (IL)

(73) Assignee: GM GLOBAL TECHNOLOGY OPERATIONS LLC, Detroit, MI (US)

(21) Appl. No.: 19/049,259

(22) Filed: Feb. 10, 2025

(51) Int. Cl. H04B 1/00

(52) U.S. Cl. CPC H04B 1/0057

(57) ABSTRACT

Presented are AM/FM/DAB/SXM radio systems with a quadplexer utilizing dual RF/DC triplexers and dual diplexer with a single front-to-back end coaxial connector cable, methods for making/using such radio systems, and vehicles equipped with such radio systems. An AM/FM/DAB/SXM radio system includes a tuner antenna module (TAM) containing a DAB front end module (FEM), a SMX FEM, and an AM/FM FEM, with a radio receiver module (RRM) containing a DAB receiver module (RXM), SMX RXM, and an AM/FM RXM. A single coax cable connects the TAM and RRM and transmits therebetween RF signals and DC power. The quadplexer, utilizing a triplexer unit and diplexer unit, is located inside the TAM and includes a FE coax port connected to the single coax cable. The triplexer unit combines AM/FM/DAB/SMX RF signals for transmission across the single coax cable to the RRM.

### INTRODUCTION

The present disclosure relates generally to amplitude-modulation/frequency-modulation (AM/FM) radio systems. More specifically, aspects of this disclosure relate to multiband AM/FM/, digital-audio-broadcasting (DAB), and satellite radio (SXM) systems for motor vehicles.

Current production motor vehicles, such as the modern-day automobile, are originally equipped with a network of onboard controllers and wireless communications devices that enable a variety of vehicle services, such as navigation assistance, multimedia entertainment, and cellular connectivity. To provide occupants with telecommunications and informatics functionality, for example, many vehicle passenger compartments are now furnished with a center-stack telematics unit that operates as both a human-machine interface (HMI) and an in-vehicle computing device for vehicle occupants. The telematics unit may wirelessly connect to a cellular network and a satellite service for such purposes as real-time navigation, customer support, vehicle diagnostics, traffic data, and satellite radio services. In general, the telematics unit functions as a bidirectional radio transceiver that is able to simultaneously transmit and receive data in the form of network data packets. Data packets may be transmitted via ultra-high frequency (UHF), super-high frequency (SHF), and/or extremely-high frequency (EHF) radio signals from a cell tower to a cellular-enabled vehicle via downlink (or download) transmission and, conversely, may be transmitted via uplink (or upload) transmission from the vehicle to a cell tower. In addition to cellular communications, many telematics units also exchange data over radio-frequency (RF) channels that provide analog “modulated” radio stations and digital “wide-band” radio stations.

### SUMMARY

Presented herein are multiband AM/FM/DAB/SXM radio systems with quadplexers including triplexers and diplexers with a single front-to-back-end connector cable, methods for manufacturing and methods for operating such radio systems, and motor vehicles equipped with such radio systems. By way of example, an automotive radio system may contain both an AM/FM tuner module (RXM) with AM/FM front end module (FEM), a DAB RXM with a DAB FEM, and a SXM RXM with a SXM FEM having individual antennas for receiving AM, FM, DAB, and SXM RF signals. However, depending upon the location of the vehicle in the world, the usage of the DAB FEM or SXM FEM, may be mutually exclusive. For example, SXM reception may be available in North America, but not in Europe. Therefore, in some instances the inclusion of both DAB and SXM antennas and both DAB and SXM RXMs may not be necessary.

Existing vehicle radio systems employ a dedicated RF coax cable to connect the AM/FM antenna and FEM to the AM/FM receiver and low-noise amplifier (LNA). Further, there may also be LNAs in the RXM with a DC power line to provide power. In addition, a separate dedicated RF coax cable to connect the DAB antenna and FEM to the DAB receiver and LNA, a separate dedicated RF coax cable to connect the SXM antenna and FEM to the SXM receiver and LNA, and discrete accessory cables for each radio for powering the front-end and back-end modules. These wiring harnesses—with all the attendant connecting points and electrical hardware—increase system complexity and expenditures, gross vehicle weight, and packaging requirements.

Disclosed herein are AM/FM/DAB/SXM radio system architectures that employ a front-end RF diplexer and a triplexer (a RF diplexer and direct current (DC)) that combines multiple FEM antenna line signals for transmission across a single coax cable, and a back-end triplexer and diplexer that separates the signals for conversion of the selected carrier frequencies by their respective receivers. Each triplexer may be integrated into a respective RF/DC triplexer unit that exchanges a direct-current (DC) voltage signal transmitted across the coax connector cable from the back-end radio receiver module (RRM, also referred to as the Central Computing Unit (CCU)) power supply to power the LNAs in the front-end Tuner Antenna Module (TAM). This system design eliminates superfluous coax and DC power cables while reducing the number of RF connectors. In addition to reducing system complexity, vehicle weight, and packaging constraints, disclosed radio system designs may also help to reduce RF signal degradation in order to maintain performance and costumer experience.

Aspects of this disclosure are directed to multiband radio systems with dual RF diplexers and triplexers with a single front-to-back end connector cable. In an example, an AM/FM/DAB/SXM radio system includes a tuner antenna module (TAM) unit including a DAB front end module (FEM) with a DAB antenna to receive DAB radio frequency (RF) signals, a SXM FEM with a SXM antenna to receive SXM radio frequency (RF) signals, and an AM/FM FEM with an AM antenna to receive AM RF signals and an FM antenna configured to receive FM RF signals. The system may also include a radio receiver module (RRM) unit with a DAB receiver module (RXM) to receive and convert the DAB RF signals into DAB audio signals, a SXM RXM to receive and convert the SXM RF signals into SXM audio signals, and an AM/FM RXM to receive and convert the AM and FM RF signals into AM/FM audio signals. The system may also include a single coaxial (coax) cable connecting the TAM unit and the RRM unit to thereby transmit therebetween RF signals and a front-end (FE) diplexer unit located in the TAM unit and including a FE DAB RF node connected to the DAB FEM to receive therefrom the DAB RF signals, and a FE SXM RF node connected to the SXM FEM to receive therefrom the SXM RF signals, the FE diplexer unit to combine the DAB RF and SXM RF signals. The system may also include a FE triplexer unit located in the TAM unit and a FE coax port connected to the single coax cable, a FE AM/FM RF node connected to the AM/FM FEM to receive therefrom the AM and FM RF signals, and a FE DAB/SXM RF node connected to the FE diplexer unit to receive the combined DAB RF and SXM RF signals, the FE triplexer unit to combine the AM, FM, DAB RF, and SXM RF signals for transmission across the single coax cable to the RRM unit.

The single coax cable may be further used to transmit direct-current (DC) power from the RRM unit to the TAM unit, and where the FE triplexer unit may further include a first, a second, and a third FE DC output nodes electrically connected to the AM/FM FEM, the DAB FEM, and the SXM FEM, respectively, to transmit thereto the DC power, the FE coax port electrically connecting the first, the second, and the third FE DC output nodes to the single coax cable.

The FE triplexer unit may further include a split-voltage line (SLV) circuit interposed between and electrically connecting the FE coax port to the first, second, and third FE DC output nodes.

The SLV circuit may include a main SLV line electrically connected in series with first and second SLV branch lines and the FE coax port, an electromagnetic interference (EMI) filter on the main SLV line, and a DC-DC BUC converter and/or a low dropout (LDO) regulator on the second SLV branch line.

The AM/FM/DAB/SXM radio system may further include where the FE triplexer utilizes a Bias-tee circuit interposed between and electrically connecting the FE coax port to the SLV circuit, the FE AM/FM RF node, the FE DAB RF node, the FE SXM RF node, the Bias-tee circuit configured to split the DC power from the RF signals transmitted across the single coax cable. The Bias-tee circuit may have a capacitor blocking DC and thus allow RF on the RF line and also an inductor blocking RF thus allowing DC on the DC line, or several inductors in series with varying values, each blocking specific RF signals (each one to block a specific frequency band) and allowing DC on the DC line.

The AM/FM/DAB/SXM radio system may further include a back-end (BE) triplexer unit located in the RRM unit and a BE coax port connected to the single coax cable, a BE AM/FM RF node connected to the AM/FM RXM to transmit thereto the AM and FM RF signals, and a BE diplexer unit located in the RRM unit and including a BE DAB RF node connected to DAB RXM to transmit thereto the DAB RF signals and a BE SXM RF node connected to SXM RXM to transmit thereto the SXM RF signals, the BE triplexer and diplexer units configured to separate the AM, FM, DAB RF, and SXM RF signals transmitted across the single coax cable from the TAM unit to the RRM unit.

The single coax cable may further be used to transmit direct-current (DC) power from the RRM unit to the TAM unit, and wherein the BE triplexer unit further includes a BE DC input node configured to electrically connect to a power source to receive therefrom the DC power, the BE coax port electrically connecting the BE DC input node to the single coax cable

The BE triplexer unit may further include a Bias-tee circuit interposed between and electrically connecting the BE coax port to the BE DC input node, the BE AM/FM RF node, and the BE diplexer unit, the Bias-tee circuit may combine the DC power with the RF signals transmitted across the single coax cable and include a capacitor blocking DC and thus allow RF on the RF line and also an inductor blocking RF thus allowing DC on the DC line, or several inductors in series with varying values, each blocking specific RF signals (each one to block a specific frequency band) and allowing DC on the DC line.

The FE triplexer unit may further include a FE elliptical RF diplexer with a FE AM/FM filter circuit connected to the AM/FM FEM, a FE DAB/SXM filter circuit connected to the FE diplexer unit, and a FE matching filter circuit connecting the FE coax port to the FE AM/FM filter circuit and the FE DAB/SXM filter circuit

The FE matching filter circuit may include a first inductor electrically connected in series with a first capacitor, the FE coax port and ground.

The FE AM/FM filter circuit may include second, third and fourth inductors electrically connected in series with the FE coax port and the FE AM/FM RF node, and second, third and fourth capacitors electrically interleaved with the second, third and fourth inductors and the FE AM/FM RF node.

The FE DAB/SXM filter circuit may include fifth, sixth and seventh capacitors electrically connected in series with the FE coax port and the FE DAB/SXM RF node, and fifth, sixth and seventh inductors electrically interleaved with the fifth, sixth and seventh capacitors and the FE DAB/SXM RF node.

The FE DAB/SXM filter circuit may further include eighth and ninth capacitors electrically connected in parallel with each other and in series with the fifth inductor and the ground, and tenth and eleventh capacitors electrically connected in parallel with each other and in series with the sixth inductor and the ground.

The FE diplexer unit may further include a FE Butterworth RF diplexer with a FE DAB filter circuit connected to the DAB FEM, a FE SXM filter circuit connected to the SXM FEM, and a FE matching filter circuit connecting the FE DAB/SXM filter circuit to the FE DAB filter circuit and the FE SXM filter circuit.

The FE matching filter circuit may further include a first inductor electrically connected in series with a first capacitor, the FE DAB/SXM filter circuit and ground.

The FE DAB filter circuit may further include second, third, and fourth inductors electrically connected in series with the FE DAB RF node and the FE DAB/SXM RF node, and second and third capacitors electrically interleaved with the second, third, and fourth inductors and the FE DAB RF node.

The FE SXM filter circuit may further include fourth, fifth, and sixth capacitors electrically connected in series with the FE SXM RF node and the FE DAB/SXM RF node, and fifth and sixth inductors electrically interleaved with the fourth, fifth, and sixth capacitors and the FE SXM RF node.

Additional aspects of this disclosure are directed to motor vehicles equipped with multiband radio systems containing dual RF triplexers and diplexers and a single front-to-back end connector cable. As used herein, the terms “vehicle” and “motor vehicle” may be used interchangeably and synonymously to include any relevant vehicle platform, such as passenger vehicles, commercial vehicles, industrial vehicles, off-road and all-terrain vehicles, tracked vehicles, farm equipment, motorcycles, watercraft, aircraft, spacecraft, etc. In an example, a motor vehicle comprises: a vehicle body including a passenger cabin; a plurality of road wheels attached to the vehicle body; a prime mover attached to the vehicle body and configured to drive one or more of the road wheels to thereby propel the motor vehicle; and an amplitude-modulation (AM), frequency-modulation (FM), and digital-audio-broadcasting (DAB) radio system attached to the vehicle body.

Continuing with the discussion of the foregoing example, the motor vehicle's AM/FM/DAB/SXM radio system may include an amplitude-modulation (AM), a frequency-modulation (FM), a digital-audio-broadcasting (DAB), and a satellite (SXM), radio system. The system may also include a tuner antenna module (TAM) unit mounted on the vehicle body and containing a DAB front end module (FEM) with a DAB antenna configured to receive DAB radio frequency (RF) signals in a DAB RF range, a SXM FEM with a SXM antenna configured to receive SXM RF signals in a SXM RF range, and an AM/FM FEM with an AM antenna configured to receive AM RF signals in an AM RF range and an FM antenna configured to receive FM RF signals in an FM RF range. Further, a radio receiver module (RRM) unit located in the passenger cabin may contain a DAB receiver module (RXM) to receive and convert the DAB RF signals into DAB audio signals, a SXM RXM to receive and convert the SXM RF signals into SXM audio signals, and an AM/FM RXM to receive and convert the AM and FM RF signals into AM/FM audio signals. In addition, a single coaxial (coax) cable may connect the TAM unit and the RRM unit to thereby transmit therebetween RF signals and direct-current (DC) power and a front-end (FE) diplexer unit located in the TAM unit and containing a FE DAB RF node connected to the DAB FEM to receive therefrom the DAB RF signals, and a FE SXM RF node connected to the SXM FEM to receive therefrom the SXM RF signals, the FE diplexer unit to combine the DAB RF and SXM RF signals. Further, a FE triplexer unit located in the TAM unit and containing a FE coax port connected to the single coax cable, first, second, and third FE DC output nodes connected to the AM/FM FEM, the DAB FEM, and the SXM FEM, respectively, to transmit thereto the DC power, a FE AM/FM RF node connected to the AM/FM FEM to receive therefrom the AM and FM RF signals, a FE DAB/SXM RF node connected to the FE diplexer unit to receive the combined DAB RF and SCM RF signals, and a FE SXM RF node connected to the SXM FEM to receive therefrom the SXM RF signals, the FE triplexer unit configured to combine the AM, FM, DAB RF, and SXM RF signals for transmission across the single coax cable to the RRM unit. The system may also include a back-end (BE) triplexer unit located in the RRM unit and containing a BE coax port connected to the single coax cable, a BE DC input node connected to a power source to receive therefrom the DC power, a BE AM/FM RF node connected to the AM/FM RXM to transmit thereto the AM and FM RF signals, and a BE diplexer unit located in the RRM unit and containing a BE DAB RF node connected to the DAB RXM to transmit thereto the DAB RF signals, and a BE SXM RF node connected to SXM RXM to transmit thereto the SXM RF signals, the BE triplexer and diplexer units configured to separate the AM, FM, DAB RF, and SXM RF signals and transmit the combined signals across the single coax cable to the RRM unit.

Aspects of this disclosure are directed to methods for making and methods for using any of the herein described multiband radio systems and/or motor vehicles. In an example, a method is presented for manufacturing an AM/FM/DAB/SXM radio system. This representative method may include, in any order and in any combination with the above and below disclosed options and features, including assembling a tuner antenna module (TAM) unit including a DAB front end module (FEM) with a DAB antenna to receive DAB radio frequency (RF) signals, a SXM front FEM with a SXM antenna to receive SXM RF signals, and an AM/FM FEM with an AM antenna to receive AM RF signals and an FM antenna configured to receive FM RF signals. The method may include assembling a radio receiver module (RRM) unit with a DAB receiver module (RXM) to receive and convert the DAB RF signals into DAB audio signals, a SXM receiver RXM to receive and convert the SXM RF signals into SXM audio signals, and an AM/FM RXM to receive and convert the AM and FM RF signals into AM/FM audio signals. The method may also include connecting the TAM unit and the RRM unit with only a single coaxial (coax) cable to thereby transmit RF signals between the TAM and RRM units and locating a front-end (FE) diplexer unit located in the TAM unit, the FE diplexer including a FE DAB RF node connected to the DAB FEM and receiving therefrom the DAB RF signals, and a FE SXM RF node connected to the SXM FEM and receiving therefrom the SXM RF signals, the FE diplexer unit to combine the DAB RF and SXM RF signals. The method may also include locating a FE triplexer unit in the TAM unit, the FE triplexer unit including a FE coax port, a FE AM/FM RF node, and a FE DAB/SXM RF node, the FE triplexer unit to combine and transmit the AM, FM, and DAB/SXM RF signals across the single coax cable and connecting the FE coax port to the single coax cable, connecting the FE AM/FM RF node to the AM/FM FEM to receive therefrom the AM and FM RF signals, and connecting the FE DAB RF node and the FE SXM RF node to the DAB FEM and SXM FEM, respectively, to receive therefrom the DAB and SXM signals.

The method may also include where the single coax cable further be used to transmit direct-current (DC) power from the RRM unit to the TAM unit, and where the FE triplexer unit further includes a first, a second, and a third FE DC output nodes, the method further including electrically connecting the first, the second, and the third FE DC output nodes to the AM/FM FEM, the DAB FEM, and the SXM FEM respectively, to transmit thereto the DC power; and electrically connecting the FE coax port to the first, the second, and the third FE DC output nodes.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with a network of in-vehicle controllers, sensors, communication devices, and centerstack telematics unit with an AM/FM/DAB/SXM radio triplexer system in accord with aspects of the present disclosure.

FIG. 2A is a diagrammatic illustration of a representative AM/FM/DAB/SXM radio system with dual RF/DC triplexers dual diplexers with a single front-to-back-end coax connector cable in accord with aspects of the present disclosure.

FIG. 2B is a detailed diagrammatic illustration of a representative tuner antenna module (TAM) of an AM/FM/DAB/SXM radio system with a single front-to-back-end coax connector cable in accord with aspects of the present disclosure.

FIG. 2C is a detailed diagrammatic illustration of a representative radio receiver module (RRM) of an AM/FM/DAB/SXM radio system with a single front-to-back-end coax connector cable in accord with aspects of the present disclosure.

FIG. 3A is a schematic illustration of a representative AM/FM/DAB/SXM RF elliptical diplexer circuit in accord with aspects of the present disclosure.

FIG. 3B is a schematic illustration of a representative DAB/SXM RF Butterworth diplexer circuit in accord with aspects of the present disclosure.

FIG. 4 is a schematic illustration of a representative Bias-tee circuit for combining or segregating RF and DC signals in the front-end and back-end RF/DC triplexers of FIG. 2 in accord with aspects of the present disclosure.

FIG. 5 is a schematic illustration of a representative Split-Line Voltage (SLV) circuit for splitting and stepping down a voltage level of a DC input signal in the front-end RF/DC triplexer of FIG. 2 in accord with aspects of the present disclosure.

FIG. 6 is a schematic illustration of another representative SLV circuit for splitting and stepping down a voltage level of a DC input signal in the front-end RF/DC triplexer of FIG. 2 in a ccord with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

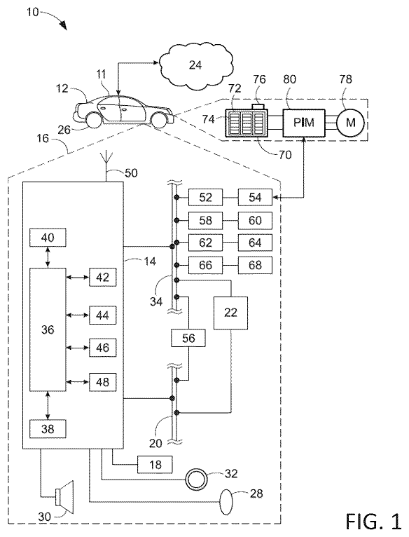

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated vehicle 10—also referred to herein as “motor vehicle” or “vehicle” for short—is merely an exemplary application with which aspects of this disclosure may be practiced. In the same vein, utilization of the present concepts for detecting and confirming the authenticity of a driver supplemental inflatable restraint (DSIR) unit should also be appreciated as a non-limiting implementation of disclosed features. As such, it will be understood that aspects of this disclosure may be employed for monitoring other in-vehicle SIR units and may be utilized for logically relevant type of motor vehicle. Moreover, select components of the motor vehicle and the vehicle SIR module are shown and described in detail herein. Nevertheless, the vehicles and SIR modules discussed below may include numerous additional and alternative features, and other available peripheral hardware, for carrying out the various methods and functions of this disclosure.

The representative vehicle 10 of FIG. 1 is originally equipped with a vehicle telecommunications and information (“telematics”) unit 14 that wirelessly communicates, e.g., via cellular network, satellite service, wireless-enabled modem, etc., with a remotely located cloud computing host service 24 (e.g., ONSTAR®). Some of the other vehicle 11 hardware components 16 shown generally in FIG. 1 include, as non-limiting examples, an electronic video display device 18, a microphone 28, audio speaker(s) 30, and assorted user input controls 32 (e.g., buttons, knobs, switches, touchpads, touchscreens, etc.). These hardware components 16 function, in part, as a human/machine interface (HMI) that enables a user to communicate with the telematics unit 14 and other components resident to and remote from the vehicle 10. Microphone 28, for instance, provides occupants with a means to input verbal commands; the vehicle 10 may be equipped with an embedded voice-processing unit utilizing audio filtering, editing, and analysis modules. Conversely, the speaker 30 provides audible output to a vehicle occupant and may be either a stand-alone speaker dedicated to the telematics unit 14 or may be part of an in-cabin audio system 22. The audio system 22 is connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware components 16 to send and receive signals with one another and with various systems both onboard and off-board the vehicle body 12. This allows the vehicle 10 to perform assorted vehicle functions, such as modulating powertrain output, activating friction and regenerative brake systems, controlling vehicle steering, and other automated functions. For instance, telematics unit 14 may exchange signals with a Powertrain Control Module (PCM) 52, an Advanced Driver Assistance System (ADAS) module 54, a Brake System Control Module (BSCM) 56, a Body Control Module (BCM) 58, a Sensor System Interface Module (SSIM) 60, and assorted other vehicle ECUs, such as a Transmission Control Module (TCM), a Sensing and Diagnostics Module (SDM), a Motor Control Module (MCM), etc.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, solid-state drive (SSD) memory, hard-disk drive (HDD) memory, phase-change memory, flash memory, semiconductor memory (e.g., various types of RAM or ROM), etc.

Long-range communication (LRC) capabilities with remote, off-board devices may be provided via one or more of a cellular chipset/component, a navigation and location chipset/component (e.g., global positioning system (GPS) transceiver), a wireless modem, or a mobile hotspot, which are collectively represented at 44. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual antenna 50. The communications devices described above may provision data exchanges as part of a periodic broadcast in a vehicle-to-vehicle (V2V) communication system or a vehicle-to-everything (V2X) communication system, e.g., Vehicle-to-Infrastructure (V2I), Vehicle-to-Pedestrian (V2P), Vehicle-to-Device (V2D), Vehicle-to-Cloud (V2C), etc.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, for executing a controller-automated (AV/ADAS) driving operation or a vehicle navigation service. In accord with the illustrated example, the vehicle 10 may be equipped with one or more digital cameras 62, one or more range sensors 64, one or more vehicle speed sensors 66, one or more vehicle dynamics sensors 68, and requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automated vehicle operation.

To propel the automobile 10, a vehicle powertrain is operable to generate and deliver tractive torque to one or more of the vehicle's drive wheels 26. The powertrain is represented in FIG. 1 by an electric traction motor (M) 78 that is operatively connected to a rechargeable energy storage system (RESS), which may be in the nature of a chassis-mounted traction battery pack 70. The traction battery pack 70 is generally composed of one or more battery modules 72 each containing a cluster of battery cells 74, such as lithium-class, zinc-class, nickel-class, or organosilicon-class cells of the pouch, prismatic, or cylindrical type. One or more prime movers, such as traction motor/generator (M) 78, draw electrical power from and, optionally, deliver electrical power to the battery pack 70. A power inverter module (PIM) 80 electrically connects the battery pack 70 to the motor(s) 78 and modulates the transfer of electrical current therebetween. The battery pack 70 may include an integrated electronics package, such as a wireless-enabled cell monitoring unit (CMU) 76, that enables on-module management, cell sensing, etc.

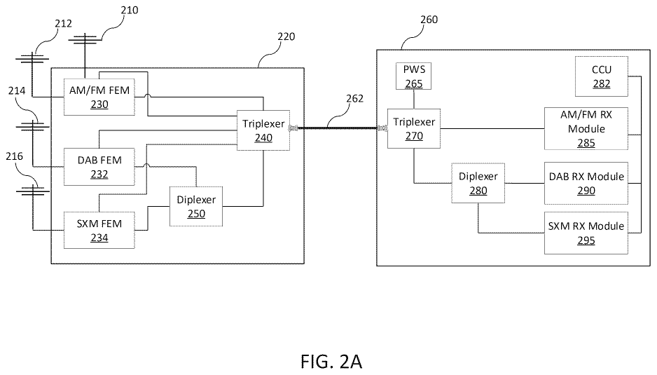

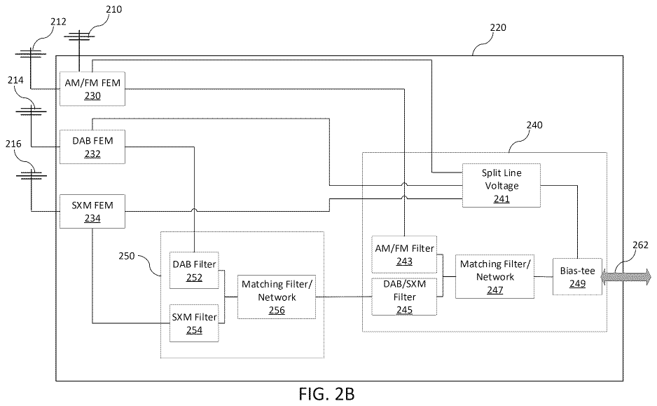

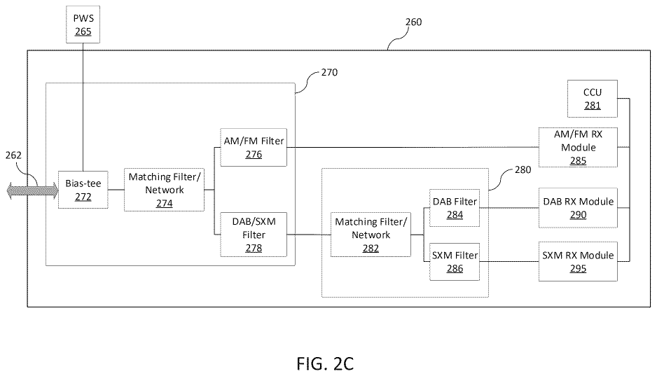

FIG. 2A is a diagrammatic illustration of a representative AM/FM/DAB/SXM radio system with dual RF/DC triplexers dual diplexers with a single front-to-back end coax connector cable, according to an embodiment of the present disclosure. The AM/FM/DAB/SXM radio system may include a Tuner Antenna Module (TAM) 220 coupled to a Radio Receiver Module (RRM) 260 through a single coax cable 262. The components within TAM 220 may also be referred to as “front end” components while components within RRM 260 may be referred to as “back end” components.

In some embodiments, RRM 260 may also be referred to as a Central Computing Unit (CCU). TAM 220 may also be coupled to multiple antennas for receiving radio signals. For example, an AM/FM front end module (FEM) 230 within TAM 220 may be coupled to an AM antenna 210 and an FM antenna 212. Further, a Digital Audio Broadcasting (DAB) FEM, within the TAM 220, may be coupled to a DAB antenna 214. And, in a similar manner, a satellite radio (SXM) FEM, within the TAM 220, may be coupled to a SXM antenna 216. While FIG. 2A illustrates the use of four antennas, the actual number of antennas that may be used in a particular scenario may be different. For example, as the presence of a DAB signal in North America may not be prevalent, the need to connect the DAB antenna 214 may not exist. In some embodiments a load may be placed on to the DAB antenna port in the DAB FEM 232, or in other embodiments no external load may be needed.

In some embodiments, while TAM 220 may include AM/FM FEM 230, DAB FEM 232, and SXM FEM 234, the radio may not include or be connected to each corresponding antenna. For example, a vehicle may include an AM antenna 210 and an FM antenna 212, and a SXM antenna 216, but not include a DAB antenna 214. Furthermore, in such situations, the corresponding RXM modules may also be eliminated. For example, in the above configuration, the DAB antenna 214 and corresponding DAB RX Module 290 may also be eliminated. In another example, while including the TAM 220 configuration, the SXM antenna 216 and SXM RX Module 295 may not be present. Also, regarding antennas, multiband antenna may also be configured for use with multiple FEM. For example, an AM/FM antenna, an AM/FM/DAB antenna, and/or a FM/DAB antenna.

TAM 220 may be designed to operate in the AM/FM, DAB, and SXM bands where the frequency ranges may include where the AM band includes approximately from 535 to 1705 kilohertz, the FM band may include a higher spectrum of approximately 88 to 108 megahertz (MHz). The DAB band may use a wide-bandwidth broadcast technology and typically spectra have been allocated for it in Band III (174-240 MHz) and L band (1.452-1.492 GHz), although the scheme may allow for operation between 30 and 300 MHz. And the SXM band may include frequencies of approximately 1970 to 2690 MHz. These frequencies are listed as examples and not meant to limit or restrict the scope of this disclosure.

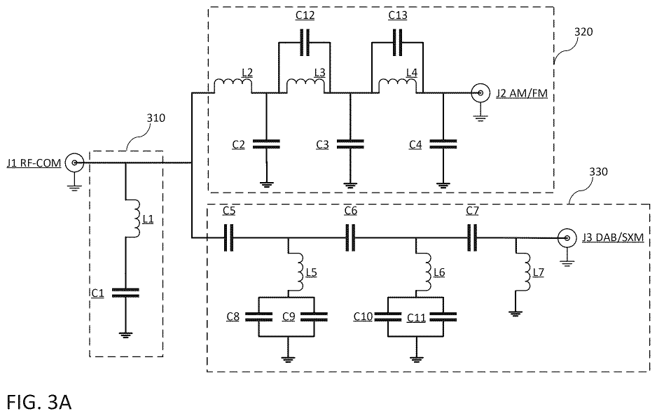

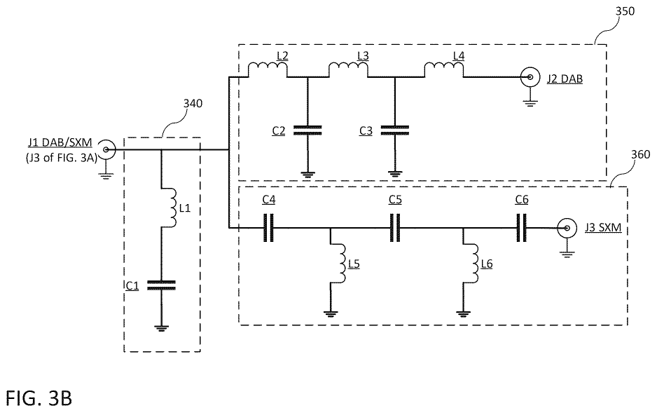

TAM 220 may also include the use of a quadplexer design as shown by the use of a cascading of diplexers/triplexers to support three RF bands, e.g., AM/FM, DAB, and SXM. The cascading diplexers may include triplexer 240 and diplexer 250 within TAM 220. Triplexer 240 may also be referred to as a front end (FE) triplexer. Triplexer 240, within TAM 220, combines the AM/FM RF signal using a low pass filter with the DAB and SXM RF signals using a high pass filter. In an embodiment, this combination may be accomplished using an Elliptical filter topology, as will be shown in FIG. 3A. Diplexer 250 may combine the DAB and SXM RF signals utilizing a Butterworth filter topology as will be shown in FIG. 3B. The Butterworth filter topology provides isolation and thus may further isolate AM/FM interference onto the DAB and SXM bands. Further, such as approach provides for minimal loss on the AM/FM frequencies as those signals pass through a single diplexer, e.g., triplexer 240. TAM 220 will be discussed in further detail in FIG. 2B.

In an AM/FM/DAB/SXM radio system TAM 220 may be coupled via the single coax cable 262 to RRM 260 that, in some embodiments, may also include a cascading set of diplexer/triplexers configured in a mirrored design to that of TAM 220. For example, RRM 260 may include triplexer 270 that receives an RF signal over the single coax cable 262. Triplexer 270 may also be referred to as a back-end (BE) triplexer. Triplexer 270 may receive an RF signal over the single coax cable 262 that includes combined AM/FM, DAB, and SXM signals. Triplexer 270 may include separating the AM/FM RF signal using a low pass filter from the DAB and SXM RF signals using a high pass filter based on an Elliptical filter topology.

In some embodiments, as will be shown in FIG. 2C, triplexer 270 may also be referred to as a triplexer that includes the functionality of an RF diplexer and the use of a phantom DC voltage where the DC voltage may be used to support other components, for example Low Noise Amplifiers (LNA's) that may be located in the FEMs, e.g., AM/FM FEM 230, DAB FEM 232, and SXM FEM 234.

Diplexer 280, in a cascading topology with triplexer 270, may take the separated DAB/SXM RF signal from triplexer 270 and separate the DAB RF signal and the SXM RF signal with a Butterworth filter topology. The outputs of triplexer 270 and diplexer 280 may then be sent to the appropriate receiver modules. For example, the AM/FM RF signal from diplexer 1 may be sent to the AM/FM RX Module 285, an AM/FM tuner, where the AM/FM RX Module 285 may receive and convert the AM and FM RF signals into audio signals. The DAB RF signal from diplexer 2 may be sent to the DAB RX Module 290, a DAB tuner, where the DAB RX Module 290 may receive and convert the DAB RF signals into audio signals. And, the SXM RF signal from diplexer 2 may be sent to the SXM RX Module 295, a SXM tuner, where the SXM RX Module 295 may receive and convert the SXM RF signals into audio signals. Further, Central Computing Unit (CCU) 281 may provide power and/or control signals to the RX modules.

In an alternate embodiment, triplexer 270 and diplexer 280 in the back end may use the Bias-tee on both sides of the coax cable, but be replaced by the use of an RF switch that may switch between the AM/FM RX Module 285, the DAB RX Module 290, and the SXM RX Module 295.

FIG. 2B is a detailed diagrammatic illustration of a representative tuner antenna module (TAM) of an AM/FM/DAB/SXM radio system with a single front-to-back-end coax connector cable, according to an embodiment of the present disclosure. FIG. 2B illustrates an embodiment with a more detailed implementation of triplexer 240 and diplexer 250. Triplexer 240 may include a Bias-tee 249 circuit, which in the triplexer 240 may be used to combine RF and a DC voltage provided by RRM 260 through the single coax cable 262. Although triplexer 240 is labeled as a “diplexer” it may also be referred to as a triplexer as it is combining the AM/FM band with the DAB and SXM bands, but it also, through the use of the Bias-tee 249 circuit, may combine a DC voltage with the RF signal. While triplexer 240 may perform the separation or combination of two sets of frequencies, it may also function to filter and control a DC component, hence the reference to a triplexer.

The DC output component of the Bias-tee 249 circuit may be directed to the split line voltage (SLV) 241 circuit. SLV 241 may be interposed between and electrically connecting the front-end coax port of the Bias-tee 249 circuit and a first, second, and third FE DC output node of the SLV 241 circuit. SLV 241 may pass or step down and split the DC power from the single coax cable 262 into one or more different DC voltages that may be routed to the various FEM circuits. In this manner, different voltages may be used by AM/FM FEM 230, DAB FEM 232, and SXM FEM 234 to power internal components, such as a low noise amplifier (LNA) in each front-end module.

Signals received by the DAB FEM 232, the DAB RF signals, and SXM FEM 234, the SXM RF signals, may be sent to diplexer 250, which may be referred to as a Butterworth diplexer. The DAB RF signals may be received by the DAB filter 252, which will be discussed in FIG. 3B. The SXM RF signals may be received by the SXM filter 254 and combined with the DAB RF signals in the matching filter/network 256 circuit. The combined DAB/SXM RF signal may then be passed to the DAB/SXM filter 245 in triplexer 240.

The output of the AM/FM FEM 230, AM RF signals and FM RF signals, may be passed directly to the AM/FM filter 243 in triplexer 240. Then, at the matching filter/network 247 circuit, using the elliptical filter topology, the DAB/SXM RF signals and the AM/FM RF signals may be further combined and passed to the Bias-tee 249 circuit in which a DC component may be added to the signal. The output of triplexer 240 may therefore be a combined AM/FM/DAB/SXM RF signal that may further include a DC component. The signal may then be passed over the single coax cable 262 to RRM 260.

FIG. 2C is a detailed diagrammatic illustration of a representative radio receiver module (RRM) of an AM/FM/DAB/SXM radio system with a single front-to-back-end coax connector cable, according to an embodiment of the present disclosure. The combined AM/FM/DAB/SXM RF signal with a DC component from triplexer 240 over the single coax cable 262 may then be received at RRM 260 by triplexer 270 with the Bias-tee 272 circuit.

Bias-tee 272 circuit may then be used to separate the DC voltage level component from the AM/FM/DAB/SXM RF signal. As discussed regarding the Bias-tee 249 circuit, the Bias-tee circuits may combine or separate an RF signal with a DC voltage component. The DC voltage is shown in FIG. 2C as being supplied by power supply 265, which may be located either internally in RRM 260 or as an external device, outside of RRM 260.

The AM/FM/DAB/SXM RF signal is passed to the back end matching filter/network 274 circuit, a back end elliptical RF topology, in which the AM/FM RF signal is separated by the AM/FM filter 276 circuit and the combination DAB/SXM RF signal is separated by the DAB/SXM filter 278 circuit.

The AM/FM RF signal from the AM/FM filter 276 circuit is then passed directly to the AM/FM RX module 285.

The DAB/SXM RF signal from the DAB/SXM filter 278 circuit may then be passed to diplexer 280 at the matching filter/network 282 circuit where the DAB RF signal is separated by the DAB filter 284 circuit and the SXM RF signal is separated by the SXM filter 286 circuit.

The DAB RF signal may then be passed to the DAB RX module 290 and the SXM RF signal may be passed to the SXM RX module 295.

SXM filter 254 may comprise relatively small capacitors and inductors and be chip based or surface mounted and may be in so-called “0201” packages or may be printed components. AM/FM Filter 243, DAB 252, and DAB/SXM filter 245, which may include larger-value inductors and capacitors due to the lower frequency of the AM/FM and the DAB signals relative to the SXM signals, may employ high-Q (that is, “high quality factor”) inductors and capacitors with reduced energy losses for better efficiency. High-Q components may be larger than other components and their use in the present system may otherwise be counterintuitive, but they may be appropriate for use in the lower-frequency environment of AM/FM filter 243, DAB 252, and DAB/SXM filter 245. Inductors in the AM/FM filter 243, DAB 252, and DAB/SXM filter 245 may in so-called “0805” packages, “0603” packages, or “0402” packages. Some or all of inductors and/or capacitors in the AM/FM filter 243 DAB 252, and DAB/SXM filter 245 may be of higher Q-factor than some or all of inductors in the SXM filter 254.

A “0805” package may be about 2.0 mm (length) by 1.2 mm (width). A “0603” package may be about 1.55 mm (length) by 0.85 mm (width). A “0402” package may be about 1.0 mm (length) by 0.5 mm (width). A “0201” package may be about 0.6 mm (length) by 0.3 mm (width).

Matching filter/network circuit 256 and 247 may be a circuit comprising an inductor and capacitor (that is, an “L-C” circuit) adapted as a matching filter or tuning filter, with an inductor and capacitor (or combinations of inductors and capacitors) selected as appropriate to tune the circuit. Matching filter/network circuit 256 and 247 may be designed to reduce signal reflections and may use larger “0805”,, “0603” or “0402” capacitors and inductors and may be high-Q or relatively high-Q components.

FIG. 3A is a schematic illustration of a representative AM/FM/DAB/SXM RF elliptical diplexer circuit, according to an embodiment of the present disclosure. As discussed in FIGS. 2A, 2B, and 2C, the triplexer 240 and the triplexer 270 may utilize an elliptical diplexer circuit to combine or separate the AM/FM RF signals from the combined DAB/SXM RF signals. FIG. 3A illustrates a matching filter/network circuit 310, an AM/FM filter 320, and a DAB/SXM filter 330. In an embodiment matching filter/network circuit 310 may include connecting to a FE coax port or a BE coax port at J1 and outputting to the AM/FM filter 320 circuit and the DAB/SXM filter circuit 330. The matching filter/network circuit 310 may include a first inductor L1 electrically connected in series with a first capacitor C1 and ground.

The AM/FM filter 320 circuit outputs to an AM/FM RF node J2 and may include a second inductor L2, a third inductor L3, and a fourth inductor L4, electrically connected in series with the coax port J1 and the AM/FM RF node at J2, and a second capacitor C2, a third capacitor C3, and a fourth capacitor C4, electrically interleaved with the second inductor L2, the third inductor L3, and the fourth inductor L4, and the AM/FM RF node at J2. The DAB/SXM filter 330 circuit outputs to an DAB/SXM RF node J3 and may include a fifth capacitor C5, a sixth capacitor C6, and a seventh capacitor C7, electrically connected in series with the FE coax port at J1and the FE DAB/SXM RF node at J3, and fifth inductor L5, sixth inductor L6, and seventh inductor L7, electrically interleaved with the fifth capacitor C5, the sixth capacitor C6, and the seventh capacitor C7, and the DAB/SXM RF node at J3.

The DAB/SXM filter 330 may further include an eighth capacitor C8 and a ninth capacitor C9 electrically connected in parallel with each other and in series with the fifth inductor L5 and the ground, and the tenth capacitor C10 and the eleventh capacitor C11 electrically connected in parallel with each other and in series with the sixth inductor L6 and the ground.

FIG. 3B is a schematic illustration of a representative DAB/SXM RF Butterwork diplexer circuit, according to an embodiment of the present disclosure. As discussed in FIGS. 2A, 2B, and 2C, the diplexer 250 and the diplexer 280 may utilize a Butterworth diplexer circuit to combine or separate the DAB RF signals and the SXM RF signals. FIG. 3B illustrates a matching filter/network circuit 340, a DAB filter 350, and an SXM filter 360. In an embodiment matching filter/network circuit 340 may include connecting to a matching filter network DAB/SXM RF node at J1, shown as J3 in FIG. 3A, and outputting to the DAB filter 350 circuit and the SXM filter circuit 360. The matching filter/network circuit 340 may include a first inductor L1 electrically connected in series with a first capacitor C1 and ground.

The DAB filter 350 circuit outputs to a DAB RF node J2 and may include a second inductor L2, a third inductor L3, and a fourth inductor L4 electrically connected in series with the DAB RF node at J2 and the FE DAB/SXM RF node at J1, and a second capacitor C2 and a third capacitor C3 electrically interleaved with the second inductor L2, the third inductor L3, and the fourth inductor L4 and the DAB RF node at J2.

The SXM filter 360 circuit outputs to an SXM RF node J3 and may include a fourth capacitor C4, a fifth capacitor C5, and a sixth capacitor C6 electrically connected in series with the SXM RF node at J3 and the DAB/SXM RF node at J1, and a fifth inductor L5 and a sixth inductor L6 electrically interleaved with the fourth capacitor C4, the fifth capacitor C5, and the sixth capacitor C6 and the SXM RF node at J3.

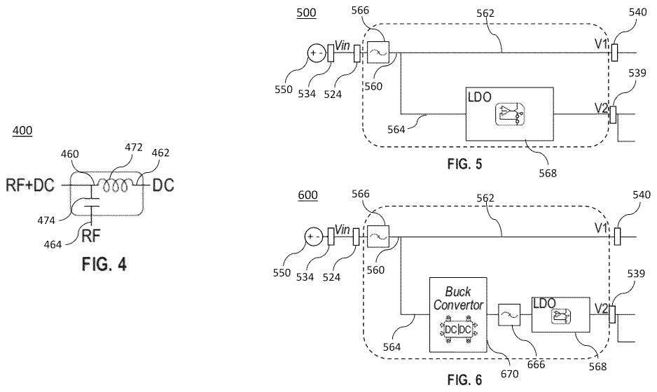

By way of non-limiting example, a representative Bias-tee (BT) circuit 400 is presented in FIG. 4, according to an embodiment of the present disclosure. BT circuit 400 may include a main BT line 460 that is electrically connected in series with a coax node J1, J3 and a pair of (first and second) BT branch lines 462 and 464. A BT resistor 472 is located on the first BT branch line 462 and electrically connected in series with the coax node J1, J3 and either the SVL circuit 241 (front end) or the PWS 265 (back end). Located on the second BT branch line 464 is a BT capacitor 474 that is electrically connected in series with the coax node J1, J3 and either the FE RF diplexer 1 250 (in the TAM 220) or the BE RF triplexer 270 (in the RRM 260). For simplicity of design and manufacture, it may be desirable that the arrangement and constituent parts of the two Bias-tee circuit 249 and Bias-tee circuit 272 be substantially identical to each other.

As noted above, a SVL circuit may be interposed between and may electrically connect a FE coax node and Bias-tee circuit to the two or more DC output nodes, as shown in SLV 241 in FIG. 2. SVL circuit 241 may be designed to step down and split the DC power received from the single coax cable (e.g., Vᵢₙ=12V DC signal) into distinct (first, second, and third (not shown)) DC voltages (e.g., V₁=12V and V₂=3V to 5V DC signals). By way of non-limiting example, a representative SVL circuit 500 is presented in FIG. 5, according to an embodiment of the present disclosure. SVL circuit 500 may include a main SVL line 560 that is electrically connected in series with the FE coax node 524 and a pair of (first and second) SVL branch lines 562 and 564, each of which connects to a respective DC output node 539, 540. In this example, an electromagnetic interference (EMI) filter 566 is located on the main SVL line 560 and a low dropout (LDO) regulator 568 is located on the second SVL branch line 564 upstream from the DC output node 539.

In another example, a representative SVL circuit 600 is presented in FIG. 6, according to an embodiment of the present disclosure. SVL circuit 600 may include an EMI filter 566 located on the main SVL line 560, and a DC-DC BUC converter 670, a second EMI filter 666, and LDO regulator 568 in series with one another on the second SVL branch line 564 upstream from the DC output node 539. Each SVL branch line 562 and 564 may transmit a respective output voltage V₁, V₂ to one of the FEMs as shown in FIG. and FIG. 3 (FEM 230, 232, and 234) to feed the internal low-noise amplifier (LNA) components inside the modules.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; modifications, changes, and variations apparent from the foregoing descriptions are within the scope of the disclosure as defined by the appended claims. Moreover, the present concepts expressly include combinations and subcombinations of the preceding elements and features.

What is claimed:

1. An amplitude-modulation (AM), a frequency-modulation (FM), a digital-audio-broadcasting (DAB), and a satellite (SXM) radio system, the AM/FM/DAB/SXM radio system comprising:
a tuner antenna module (TAM) unit including a DAB front end module (FEM) with a DAB antenna configured to receive DAB radio frequency (RF) signals, a SXM FEM with a SXM antenna configured to receive SXM radio frequency (RF) signals, and an AM/FM FEM with an AM antenna configured to receive AM RF signals and an FM antenna configured to receive FM RF signals;
a radio receiver module (RRM) unit including a DAB receiver module (RXM) configured to receive and convert the DAB RF signals into DAB audio signals, a SXM RXM configured to receive and convert the SXM RF signals into SXM audio signals, and an AM/FM RXM configured to receive and convert the AM and FM RF signals into AM/FM audio signals;
a single coaxial (coax) cable connecting the TAM unit and the RRM unit to thereby transmit therebetween RF signals;
a front-end (FE) diplexer unit located in the TAM unit and including a FE DAB RF node connected to the DAB FEM to receive therefrom the DAB RF signals, and a FE SXM RF node connected to the SXM FEM to receive therefrom the SXM RF signals, the FE diplexer unit configured to combine the DAB RF and SXM RF signals; and
a FE triplexer unit located in the TAM unit and including a FE coax port connected to the single coax cable, a FE AM/FM RF node connected to the AM/FM FEM to receive therefrom the AM and FM RF signals, and a FE DAB/SXM RF node connected to the FE diplexer unit to receive the combined DAB RF and SXM RF signals, the FE triplexer unit configured to combine the AM, FM, DAB RF, and SXM RF signals for transmission across the single coax cable to the RRM unit.

2. The AM/FM/DAB/SXM radio system of claim 1, wherein the single coax cable is further configured to transmit direct-current (DC) power from the RRM unit to the TAM unit, and wherein the FE triplexer unit further includes a first, a second, and a third FE DC output nodes electrically connected to the AM/FM FEM, the DAB FEM, and the SXM FEM, respectively, to transmit thereto the DC power, the FE coax port electrically connecting the first, the second, and the third FE DC output nodes to the single coax cable.

3. The AM/FM/DAB/SXM radio system of claim 2, wherein the FE triplexer unit further includes a split-voltage line (SLV) circuit interposed between and electrically connecting the FE coax port to the first, the second, and the third FE DC output nodes.

4. The AM/FM/DAB/SXM radio system of claim 3, wherein the SLV circuit includes a main SLV line electrically connected in series with first and second SLV branch lines and the FE coax port, an electromagnetic interference (EMI) filter on the main SLV line, and a DC-DC BUC converter and/or a low dropout (LDO) regulator on the second SLV branch line.

5. The AM/FM/DAB/SXM radio system of claim 3, wherein the FE triplexer unit further includes a Bias-tee circuit interposed between and electrically connecting the FE coax port to the SLV circuit, the FE AM/FM RF node, the FE DAB RF node, the FE SXM RF node, the Bias-tee circuit configured to split the DC power from the RF signals transmitted across the single coax cable.

6. The AM/FM/DAB/SXM radio system of claim 1, further comprising a back-end (BE) triplexer unit located in the RRM unit and including a BE coax port connected to the single coax cable, a BE AM/FM RF port connected to the AM/FM RXM to transmit thereto the AM and FM RF signals, and a BE diplexer unit located in the RRM unit and including a BE DAB RF node connected to DAB RXM to transmit thereto the DAB RF signals and a BE SXM RF node connected to SXM RXM to transmit thereto the SXM RF signals, the BE triplexer and diplexer units configured to separate the AM, FM, DAB RF, and SXM RF signals transmitted across the single coax cable from the TAM unit to the RRM unit.

7. The AM/FM/DAB/SXM radio system of claim 6, wherein the single coax cable is further configured to transmit direct-current (DC) power from the RRM unit to the TAM unit, and wherein the BE triplexer unit further includes a BE DC input node configured to electrically connect to a power source to receive therefrom the DC power, the BE coax port electrically connecting the BE DC input node to the single coax cable.

8. The AM/FM/DAB/SXM radio system of claim 7, wherein the BE triplexer unit further includes a Bias-tee circuit interposed between and electrically connecting the BE coax port to the BE DC input node, the BE AM/FM RF node, and the BE diplexer unit, the Bias-tee circuit configured to combine the DC power with the RF signals transmitted across the single coax cable.

9. The AM/FM/DAB/SXM radio system of claim 1, wherein the FE triplexer unit further includes a FE elliptical RF diplexer with a FE AM/FM filter circuit connected to the AM/FM FEM, a FE DAB/SXM filter circuit connected to the FE diplexer unit, and a FE matching filter circuit connecting the FE coax port to the FE AM/FM filter circuit and the FE DAB/SXM filter circuit.

10. The AM/FM/DAB/SXM radio system of claim 9, wherein the FE matching filter circuit includes a first inductor electrically connected in series with a first capacitor, the FE coax port and ground.

11. The AM/FM/DAB/SXM radio system of claim 10, wherein the FE AM/FM filter circuit includes second, third and fourth inductors electrically connected in series with the FE coax port and the FE AM/FM RF node, and second, third and fourth capacitors electrically interleaved with the second, third and fourth inductors and the FE AM/FM RF node.

12. The AM/FM/DAB/SXM radio system of claim 11, wherein the FE DAB/SXM filter circuit includes fifth, sixth and seventh capacitors electrically connected in series with the FE coax port and the FE DAB/SXM RF node, and fifth, sixth and seventh inductors electrically interleaved with the fifth, sixth and seventh capacitors and the FE DAB/SXM RF node.

13. The AM/FM/DAB/SXM radio system of claim 12, wherein the FE DAB/SXM filter circuit further includes eighth and ninth capacitors electrically connected in parallel with each other and in series with the fifth inductor and the ground, and tenth and eleventh capacitors electrically connected in parallel with each other and in series with the sixth inductor and the ground.

14. The AM/FM/DAB/SXM radio system of claim 9, wherein the FE diplexer unit further includes a FE Butterworth RF diplexer with a FE DAB filter circuit connected to the DAB FEM, a FE SXM filter circuit connected to the SXM FEM, and a FE matching filter circuit connecting the FE DAB/SXM filter circuit to the FE DAB filter circuit and the FE SXM filter circuit.

15. The AM/FM/DAB/SXM radio system of claim 14, wherein the FE matching filter circuit includes a first inductor electrically connected in series with a first capacitor, the FE DAB/SXM filter circuit and ground.

16. The AM/FM/DAB/SXM radio system of claim 15, wherein the FE DAB filter circuit includes second, third, and fourth inductors electrically connected in series with the FE DAB RF node and the FE DAB/SXM RF node, and second and third capacitors electrically interleaved with the second, third, and fourth inductors and the FE DAB RF node.

17. The AM/FM/DAB/SXM radio system of claim 16, wherein the FE SXM filter circuit includes fourth, fifth, and sixth capacitors electrically connected in series with the FE SXM RF node and the FE DAB/SXM RF node, and fifth and sixth inductors electrically interleaved with the fourth, fifth, and sixth capacitors and the FE SXM RF node.

18. A motor vehicle, comprising:
a vehicle body including a passenger cabin;
a plurality of road wheels attached to the vehicle body;
a prime mover attached to the vehicle body and configured to drive one or more of the road wheels to thereby propel the motor vehicle; and
an amplitude-modulation (AM), a frequency-modulation (FM), a digital-audio-broadcasting (DAB), and a satellite (SXM), radio system, including:
a tuner antenna module (TAM) unit mounted on the vehicle body and containing a DAB front end module (FEM) with a DAB antenna configured to receive DAB radio frequency (RF) signals in a DAB RF range, a SXM FEM with a SXM antenna configured to receive SXM RF signals in a SXM RF range, and an AM/FM FEM with an AM antenna configured to receive AM RF signals in an AM RF range and an FM antenna configured to receive FM RF signals in an FM RF range;
a radio receiver module (RRM) unit located in the passenger cabin and containing a DAB receiver module (RXM) configured to receive and convert the DAB RF signals into DAB audio signals, a SXM RXM configured to receive and convert the SXM RF signals into SXM audio signals, and an AM/FM RXM configured to receive and convert the AM and FM RF signals into AM/FM audio signals;
a single coaxial (coax) cable connecting the TAM unit and the RRM unit to thereby transmit therebetween RF signals and direct-current (DC) power;
a front-end (FE) diplexer unit located in the TAM unit and containing a FE DAB RF node connected to the DAB FEM to receive therefrom the DAB RF signals, and a FE SXM RF node connected to the SXM FEM to receive therefrom the SXM RF signals, the FE diplexer unit configured to combine the DAB RF and SXM RF signals;
a FE triplexer unit located in the TAM unit and containing a FE coax port connected to the single coax cable, first, second, and third FE DC output nodes connected to the AM/FM FEM, the DAB FEM, and the SXM FEM, respectively, to transmit thereto the DC power, a FE AM/FM RF node connected to the AM/FM FEM to receive therefrom the AM and FM RF signals, a FE DAB/SXM RF node connected to the FE diplexer unit to receive the combined DAB RF and SCM RF signals, and a FE SXM RF node connected to the SXM FEM to receive therefrom the SXM RF signals, the FE triplexer unit configured to combine the AM, FM, DAB RF, and SXM RF signals for transmission across the single coax cable to the RRM unit; and
a back-end (BE) triplexer unit located in the RRM unit and containing a BE coax port connected to the single coax cable, a BE DC input node connected to a power source to receive therefrom the DC power, a BE AM/FM RF node connected to the AM/FM RXM to transmit thereto the AM and FM RF signals, and a BE diplexer unit located in the RRM unit and containing a BE DAB RF node connected to the DAB RXM to transmit thereto the DAB RF signals, and a BE SXM RF node connected to SXM RXM to transmit thereto the SXM RF signals, the BE triplexer and diplexer units configured to separate the AM, FM, DAB RF, and SXM RF signals and transmit the combined signals across the single coax cable to the RRM unit.

19. A method of manufacturing an amplitude-modulation (AM), a frequency-modulation (FM), a digital-audio-broadcasting (DAB), and a satellite (SXM), radio system, the method comprising:
assembling a tuner antenna module (TAM) unit including a DAB front end module (FEM) with a DAB antenna configured to receive DAB radio frequency (RF) signals, a SXM front FEM with a SXM antenna configured to receive SXM RF signals, and an AM/FM FEM with an AM antenna configured to receive AM RF signals and an FM antenna configured to receive FM RF signals;
assembling a radio receiver module (RRM) unit with a DAB receiver module (RXM) configured to receive and convert the DAB RF signals into DAB audio signals, a SXM receiver RXM configured to receive and convert the SXM RF signals into SXM audio signals, and an AM/FM RXM configured to receive and convert the AM and FM RF signals into AM/FM audio signals;
connecting the TAM unit and the RRM unit with only a single coaxial (coax) cable to thereby transmit RF signals between the TAM and RRM units;
locating a front-end (FE) diplexer unit located in the TAM unit, the FE diplexer including a FE DAB RF node connected to the DAB FEM and receiving therefrom the DAB RF signals, and a FE SXM RF node connected to the SXM FEM and receiving therefrom the SXM RF signals, the FE diplexer unit configured to combine the DAB RF and SXM RF signals; and
locating a FE triplexer unit in the TAM unit, the FE triplexer unit including a FE coax port, a FE AM/FM RF node, and a FE DAB/SXM RF node, the FE triplexer unit configured to combine and transmit the AM, FM, and DAB/SXM RF signals across the single coax cable;
connecting the FE coax port to the single coax cable;
connecting the FE AM/FM RF node to the AM/FM FEM to receive therefrom the AM and FM RF signals; and
connecting the FE DAB RF node and the FE SXM RF node to the DAB FEM and SXM FEM, respectively, to receive therefrom the DAB and SXM signals.

20. The method of claim 19, wherein the single coax cable is further configured to transmit direct-current (DC) power from the RRM unit to the TAM unit, and wherein the FE triplexer unit further includes a first, a second, and a third FE DC output nodes, the method further comprising:
electrically connecting the first, the second, and the third FE DC output nodes to the AM/FM FEM, the DAB FEM, and the SXM FEM respectively, to transmit thereto the DC power; and
electrically connecting the FE coax port to the first, the second, and the third FE DC output nodes.
